(19) United States
(12) Patent Application Publication
(10) Pub. No.: US 2026/0370090 A1
(43) Pub. Date: Nov. 19, 2026

(54) ELECTRICITY GENERATOR SYSTEM FOR CONVERTING KINETIC ENERGY OF MOVING VEHICLES ON ROADWAYS

(71) Applicant: eWay Technology LLC, New Orleans, LA (US)

(72) Inventor: Dwayne White, JR., New Orleans, LA (US)

(73) Assignee: eWay Technology LLC, New Orleans, LA (US)

(21) Appl. No.: 19/208,778

(22) Filed: May 15, 2025

(51) Int. Cl. H02K 7/18; H02K 7/116

(52) U.S. Cl. CPC H02K 7/1861; H02K 7/116

(57) ABSTRACT

An electricity generator system for converting kinetic energy of moving vehicles on roadways includes a roller, a pair of supports, a gear system, a motor, and an AC generator. The roller includes a body and a pair of axle portions. The roller is designed to be positioned horizontally in a roadway such that the roller is partially exposed and flush with a top surface of the roadway. The roller is rotatable in the supports by contact with tires of moving vehicles driving on the roadway. The gear system is coupled to a respective one of the axle portions for transmission of drive force. The motor is coupled to the gear system. The AC generator is coupled to the motor. The AC generator is designed to generate electricity from rotation of the roller by moving vehicles or from operation of the motor when the roller is not rotating.

### (a) TITLE OF THE INVENTION

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) the Names of the Parties to a Joint Research Agreement

Not Applicable

### (e) Incorporation-by-reference of Material Submitted on a Compact Disc or as a Text File via the Office Electronic Filing System

Not Applicable

### (f) Statement Regarding Prior Disclosures by the Inventor or Joint Inventor

Not Applicable

### (g) Background of the Invention

### (1) Field of the Invention.

The disclosure relates to electricity generators and more particularly pertains to a new electricity generator system for converting kinetic energy of moving vehicles on roadways. Many systems exist that are used to generate electricity by harnessing the kinetic energy generated by operation of everyday devices. The new electricity generator system utilizes a roller that is positioned in a roadway and connected to an AC generator. The roller is driven on and rotated by the tires of moving vehicles. The rotational drive force of the roller drives the AC generator, thereby resulting in the generation of electricity by the movement of the vehicles on the roadway.

### (2) Description of Related Art Including Information Disclosed Under 37 CFR 1.97 and 1.98

The prior art relates to electricity generators that convert kinetic energy of vehicles by physical compression or depression of components of the devices by the weight of vehicles driving over the devices. The prior art, as best understood, does not disclose an electricity generator system for converting kinetic energy of moving vehicles on roadways that includes a roller, a pair of supports, a gear system, a motor, and an AC generator, wherein the roller is rotated by tires of moving vehicles, and the AC generator is designed to generate electricity from rotation of the roller by moving vehicles or from operation of the motor when the roller is not rotating.

### (h) BRIEF SUMMARY OF THE INVENTION

An embodiment of the disclosure meets the needs presented above in a electricity generator system generally comprising a roller, a pair of supports, a gear system, a motor, and an AC generator. The roller includes a body and a pair of axle portions projecting out of respective ends of the body. The body is cylindrical and elongated to extend across a roadway. The roller is designed to be positioned horizontally in a roadway such that the roller is partially exposed and flush with a top surface of the roadway. Each of the supports is coupled to a respective one of the axle portions such that the roller is rotatable by contact with tires of moving vehicles driving on the roadway. The supports are positionable in the roadway. The gear system is coupled to a respective one of the axle portions for transmission of drive force. The motor is coupled to the gear system. The AC generator is coupled to the motor. The AC generator is designed to generate electricity from rotation of the roller by moving vehicles or from operation of the motor when the roller is not rotating.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(s)

The disclosure will be better understood and objects other than those set forth above will become apparent when consideration is given to the following detailed description thereof. Such description makes reference to the annexed drawings wherein:

FIG. 1 is a front view of an electricity generator system according to an embodiment of the disclosure.

FIG. 2 is a close-up view of a component of an embodiment of the disclosure.

FIG. 3 is a front view of an alternative embodiment of the disclosure.

FIG. 4 is a block diagram of components of an embodiment of the disclosure.

FIG. 5 is a front view of an alternative embodiment of the electricity generator system.

FIG. 6 is a side view of a component of the alternative embodiment of the electricity generator system.

FIG. 7 is a block diagram of components of the alternative embodiment of the electricity generator system.

### (J) DETAILED DESCRIPTION OF THE INVENTION

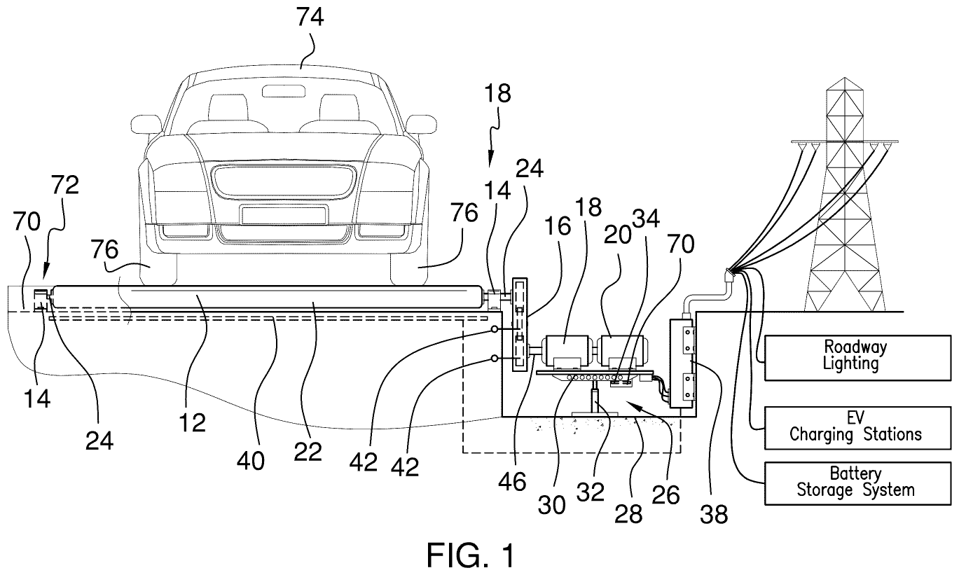

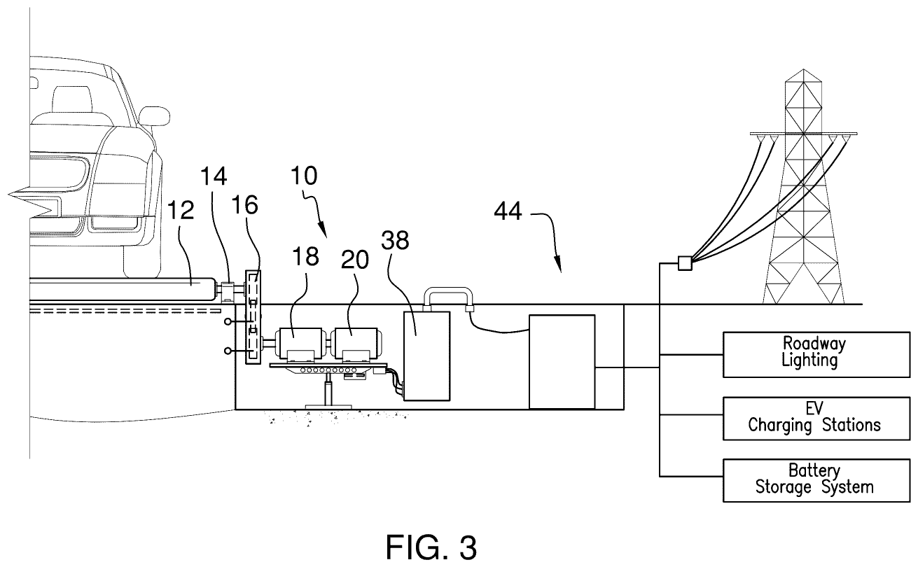

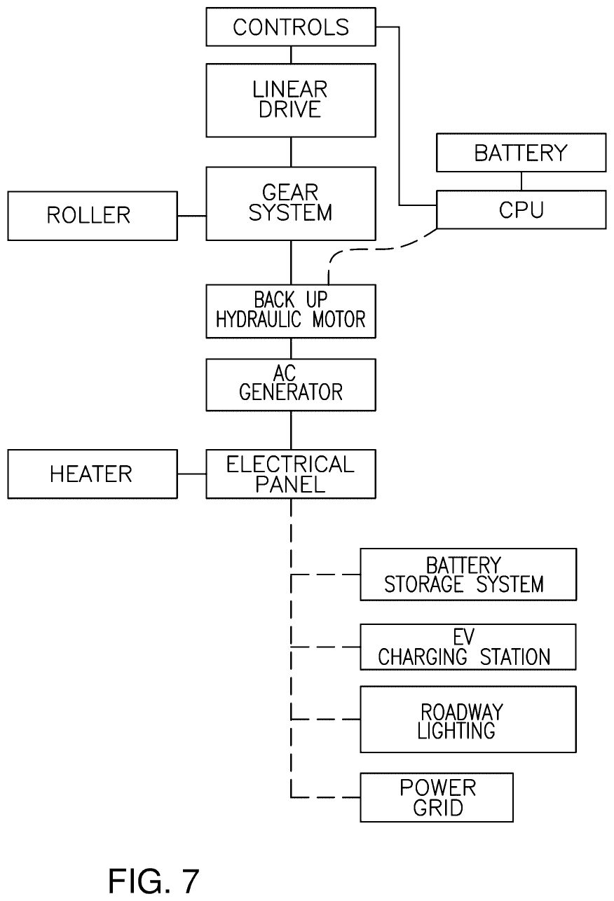

With reference now to the drawings, and in particular to FIGS. 1 through 7 thereof, a new electricity generator system embodying the principles and concepts of an embodiment of the disclosure and generally designated by the reference numeral 10 will be described.

As best illustrated in FIGS. 1 through 7, the electricity generator system 10 generally comprises a roller 12, a pair of supports 14, a gear system 16, a motor 18, and an AC (alternating current) generator 20. The roller 12 includes a body 22 and a pair of axle portions 24 projecting out of respective ends of the body 22. The body 22 is cylindrical and elongated to extend across a roadway 70. The roller 12 is designed to be positioned horizontally in the roadway 70 such that the roller 12 is partially exposed and flush with a top surface 72 of the roadway 70. Each of the supports 14 is coupled to a respective one of the axle portions 24 such that the roller 12 is rotatable by contact with tires of moving vehicles driving on the roadway 70. The supports 14 are positionable in the roadway 70. The gear system 16 is coupled to a respective one of the axle portions 24 for transmission of drive force. The motor 18 is coupled to the gear system 16. The AC generator 20 is coupled to the motor 18. The AC generator 20 is designed to generate electricity from rotation of the roller 12 by moving vehicles or from operation of the motor 18 when the roller 12 is not rotating.

The roller 12 is non-conductive. For example, the roller 12 could be made of a non-conductive material, such as a non-conductive plastic or rubber. The roller 12 could also have an outer layer or coating of non-conductive material.

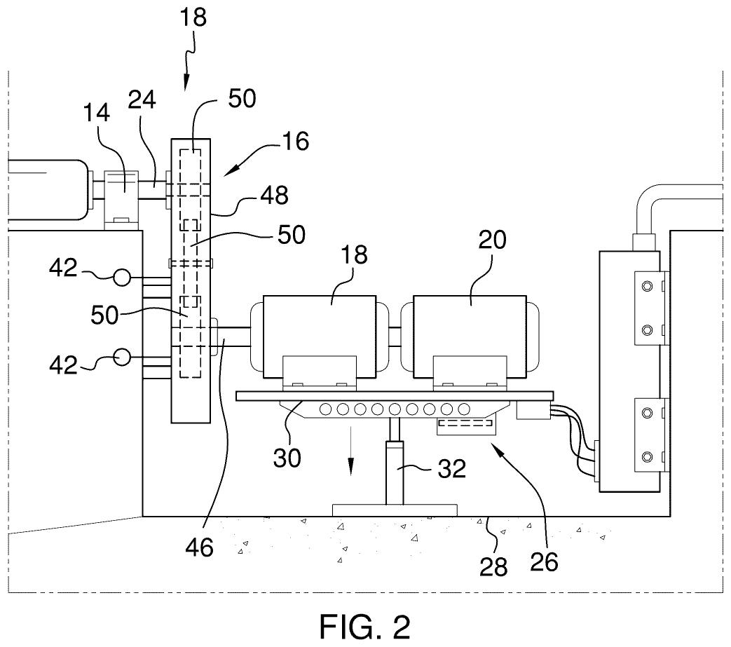

A support 26 is positioned in a compartment 28 adjacent the roadway 70. The compartment 28 is shown in FIG. 1 as being open for purposes of illustration, though for safety the compartment 28 would be a closed container accessible via a lid or door or panel. In the exemplary embodiment in FIGS. 1 and 2, the gear system 16 includes a gear housing 48 and three gears 50. The gear housing 48 is mounted in the compartment 28 and supports two of the three gears 50. The lowermost of the gears 50 is supported on a driveshaft 46 of the motor 18. Each of the motor 18 and the AC generator 20 is mounted on the support 26. The support 26 includes a platform 30 and a lift 32 to adjust a vertical position of the platform 30. As shown in FIG. 2, the lift 32 can be lowered to disengage the lowermost of the gears 50 from the other gears 50. In this position, only the motor 18 is driving the AC generator 20. This position can be utilized during times of low traffic since the roller 12 will not be in operation. The lift 32 could also be used to dissipate forces and stabilize the components, as is well known in the mechanical arts. Other types of supports, such as shock absorbers or stationary frames, are within the scope of the disclosure.

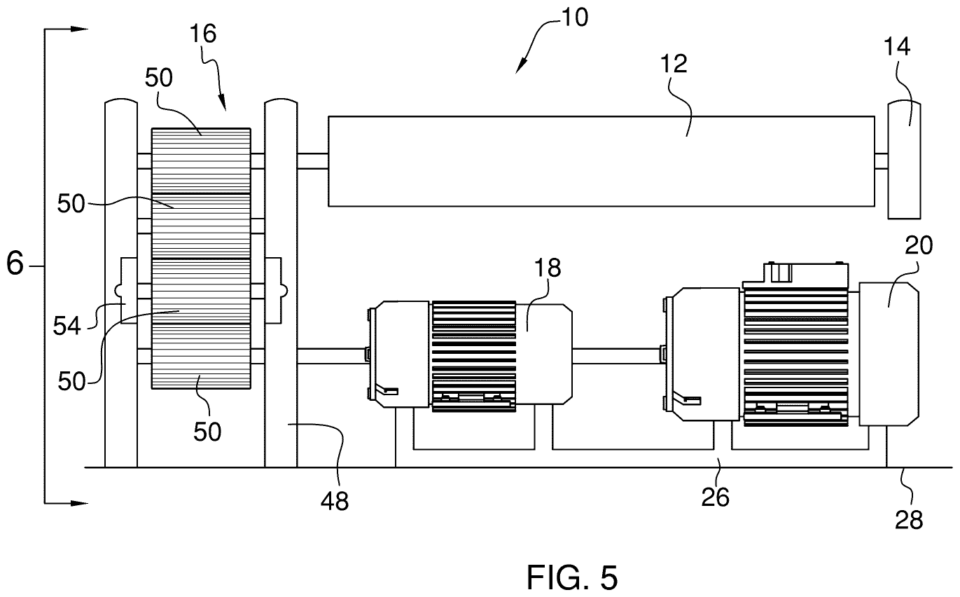

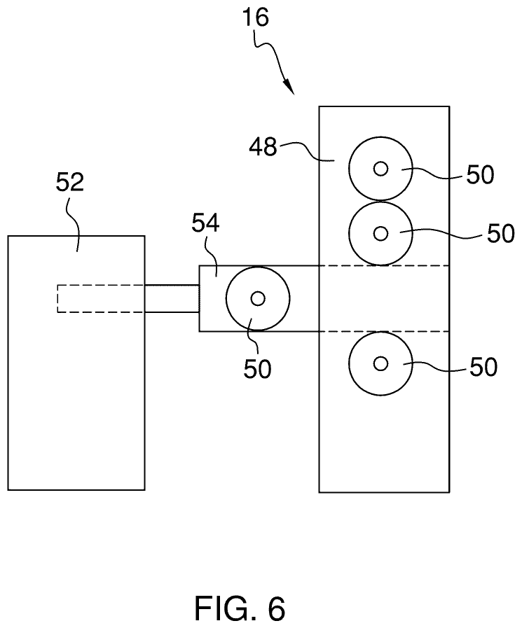

FIGS. 5 through 7 show an alternative design of the electricity generator system 10, specifically how the gear system 16 is engaged and disengaged. The support 26 is stationary and does not include the platform 30 and the lift 32. As shown in FIG. 6, a linear drive 52 is coupled to the gear housing 48. The gear housing 48 includes a detachable journal 54 positioned to support one of the gears 50. The linear drive 52 is coupled to the detachable journal 54 to selectively move the one of the gears 50 supported on the detachable journal 54 in and out of the gear housing 48 and thus in and out of engagement with the others of the gears 50. Again, the disengagement can be utilized during times of low traffic since the roller 12 will not be in operation.

The electricity generator system 10 also includes a microprocessor 34 and a battery 36 to supply power to the microprocessor 34. The microprocessor 34 is designed to control operation of the lift 32 and the motor 18. As shown in FIG. 2, the microprocessor 34, or central processing unit (CPU), is connected to a set of controls for the operation of the lift 32, which can be a linear actuator stand.

The electricity generator system 10 also includes an electrical panel 38 electrically coupled to the AC generator 20. The electrical panel 38 is designed to connect to at least one of a power grid, roadway lighting, electric vehicle charging stations, and a battery storage system. The electrical panel 38 can also be connected to other devices or electrical storage.

The electricity generator system 10 also includes a heater 40 that is positioned adjacent the roller 12 to heat the roller 12 in cold temperatures. The heater 40 is in the form of an elongated strip. In the exemplary embodiment, the heater 40 is a radiant electrical heat device that is connected to the electrical panel 38 to receive power, as shown in FIG. 2, or, in another possible embodiment, to another suitable power source. Other types of heaters, such as fuel-based heaters, could be used in one possible embodiment.

The electricity generator system 10 also includes an RPM sensor 42 coupled to the gear system 16. The RPM sensor 42 monitors the revolutions per minute (RPM) of the gears in the gear system 16.

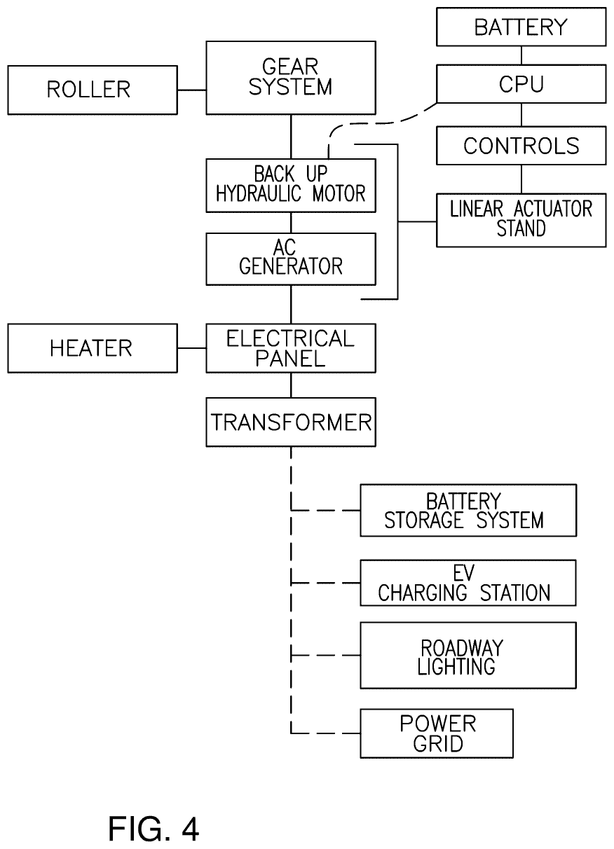

In the alternative embodiment in FIG. 4, the electricity generator system 10 also includes an electrical transformer 44 electrically coupled to the electrical panel 38 to step up or step down voltage, as is well known in the electrical arts. FIG. 4 shows an example of a possible electrical transformer 44 that could be used or adapted for use in the electricity generator system 10.

In operation, the roller 12 of the electricity generator system 10 is positioned in the roadway 70 or other driving surface, such as a parking lot. As vehicles, such as a car 74, drive over the roller 12, tires 76 of the vehicles cause the roller 12 to spin. The spinning roller 12 turns the gears of the gear system 16, which then turns a driveshaft 46 of the backup motor 18. The driveshaft 46 is also coupled to the AC generator 20, or the driveshaft 46 is coupled to a separate, second, driveshaft of the AC generator 20. In one possible embodiment, the backup motor 18 could be omitted and the gear system 16 directly coupled to the AC generator 20. The drive force from the roller 12 is used to drive the driveshaft 46 of the AC generator 20 to generate electricity. The electricity is then transmitted to the electrical panel 38 for distribution. The motor 18 is a backup in the event of failure of the roller 12 or the gear system 16, or possibly during periods of inactivity of the roller 12, such as at late night hours when there are very few vehicles on the roadway 70, to continue to drive the AC generator 20 and supply power. In the exemplary embodiment, the motor 18 is a hydraulic motor. In one possible embodiment, the motor 18 could be powered by electricity or fuel and can be activated by the microprocessor 34 when needed or on a schedule. In the alternative embodiment, the electricity travels from the electrical panel 38 to the transformer. In this manner, electricity can be generated by the movement of moving vehicles.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electricity generator system for converting kinetic energy of moving vehicles on roadways comprising:
a roller, the roller including a body and a pair of axle portions projecting out of respective ends of the body, the body being cylindrical and elongated to extend across a roadway, the roller being configured to be positioned horizontally in a roadway such that the roller is partially exposed and flush with a top surface of the roadway;
a pair of supports, each of the supports being coupled to a respective one of the axle portions such that the roller is rotatable by contact with tires of moving vehicles driving on the roadway, the supports being positionable in the roadway;
a gear system, the gear system being coupled to a respective one of the axle portions for transmission of drive force;
a motor, the motor being coupled to the gear system; and
an AC generator, the AC generator being coupled to the motor, the AC generator being configured to generate electricity from rotation of the roller by moving vehicles or from operation of the motor when the roller is not rotating.

2. The electricity generator system of claim 1, wherein the roller is non-conductive.

3. The electricity generator system of claim 1, further comprising a support being positioned in a compartment adjacent the roadway, each of the motor and the AC generator being mounted on the support, wherein the gear system includes a gear housing mounted in the compartment and a plurality of gears positioned in the gear housing.

4. The electricity generator system of claim 3, wherein:
the motor includes a driveshaft coupled to and supporting a lowermost one of the gears; and
the support includes a platform and a lift to adjust a vertical position of the platform to move the motor up and down and thereby move the lowermost one of the gears in and out of engagement with the others of the gears.

5. The electricity generator system of claim 3, further comprising a linear drive coupled to the gear housing, wherein:
the gear housing includes a detachable journal positioned to support one of the gears; and
the linear drive is coupled to the detachable journal to selectively move the one of the gears supported on the detachable journal in and out of the gear housing and thus in and out of engagement with the others of the gears.

6. The electricity generator system of claim 1, further comprising a microprocessor and a battery to supply power to the microprocessor, the microprocessor being configured to control operation of the lift and the motor.

7. The electricity generator system of claim 1, further comprising an electrical panel electrically coupled to the AC generator, the electrical panel being configured to connect to at least one of a power grid, roadway lighting, electric vehicle charging stations, and a battery storage system.

8. The electricity generator system of claim 7, further comprising an electrical transformer electrically coupled to the electrical panel to step up or step down voltage.

9. The electricity generator system of claim 7, further comprising a heater being positioned adjacent the roller to heat the roller in cold temperatures.

10. The electricity generator system of claim 9, wherein the heater is connected to the electrical panel to receive power.

11. The electricity generator system of claim 1, further comprising an RPM sensor coupled to the gear system.

12. The electricity generator system of claim 2, further comprising a support being positioned in a compartment adjacent the roadway, each of the motor and the AC generator being mounted on the support, wherein the gear system includes a gear housing mounted in the compartment and a plurality of gears positioned in the gear housing.

13. The electricity generator system of claim 12, wherein:
the motor includes a driveshaft coupled to and supporting a lowermost one of the gears; and
the support includes a platform and a lift to adjust a vertical position of the platform to move the motor up and down and thereby move the lowermost one of the gears in and out of engagement with the others of the gears.

14. The electricity generator system of claim 13, further comprising a microprocessor and a battery to supply power to the microprocessor, the microprocessor being configured to control operation of the lift and the motor.

15. The electricity generator system of claim 14, further comprising an electrical panel electrically coupled to the AC generator, the electrical panel being configured to connect to at least one of a power grid, roadway lighting, electric vehicle charging stations, and a battery storage system.

16. The electricity generator system of claim 15, further comprising an electrical transformer electrically coupled to the electrical panel to step up or step down voltage.

17. The electricity generator system of claim 16, further comprising a heater being positioned adjacent the roller to heat the roller in cold temperatures, the heater being connected to the electrical panel to receive power.

18. The electricity generator system of claim 17, further comprising an RPM sensor coupled to said gear system.

19. The electricity generator system of claim 12, further comprising a linear drive coupled to the gear housing, wherein:
the gear housing includes a detachable journal positioned to support one of the gears; and
the linear drive is coupled to the detachable journal to selectively move the one of the gears supported on the detachable journal in and out of the gear housing and thus in and out of engagement with the others of the gears.

20. The electricity generator system of claim 19, further comprising:
a microprocessor and a battery to supply power to the microprocessor, the microprocessor being configured to control operation of the linear drive and the motor;
an electrical panel electrically coupled to the AC generator, the electrical panel being configured to connect to at least one of a power grid, roadway lighting, electric vehicle charging stations, and a battery storage system;
an electrical transformer electrically coupled to the electrical panel to step up or step down voltage;
a heater being positioned adjacent the roller to heat the roller in cold temperatures, the heater being connected to the electrical panel to receive power; and
an RPM sensor coupled to said gear system.
